(19) United States
(12) Patent Application Publication
(10) Pub. No.: US 2012/0222623 A1
(43) Pub. Date: Sep. 6, 2012

(54) WALL MOUNTED MODULAR PET BED

(76) Inventor: Katherine Moore, Ladue, MO (US)

(21) Appl. No.: 13/409,669

(22) Filed: Mar. 1, 2012

Related U.S. Application Data
(60) Provisional application No. 61/448,039, filed on Mar. 1, 2011.

(51) Int. Cl. A01K 29/00; B65B 1/04

(52) U.S. Cl. 119/28.5; 119/174; 53/473

(57) ABSTRACT

A modular pet assembly having a pair of end members that define an opening sized and shaped for the entrance and exit of a pet. At least one end member is configured for wall mounting at a selected elevation. A lateral member interchangeably engages between the end members at a plurality of locations for arrangement of the modular pet assembly in a plurality of configurations. The pet assembly assembles into a configuration for accommodating a pet, and disassembles into a configuration for storage and shipping.

### CROSS-REFERENCE TO RELATED APPLICATIONS

This Non-Provisional application claims priority to U.S. Provisional Application Ser. No. 61/448,039 filed Mar. 1, 2011, and which is incorporated herein by reference.

### STATEMENT REGARDING FEDERALLY SPONSORED RESEARCH

Not Applicable.

### BACKGROUND OF THE INVENTION

The disclosure is generally related to wall mounted pet beds, and more specifically to wall mounted modular pet beds.

Some domesticated animals, and in particular cats, have a fondness of perching. According to animal behaviorists, cats favor high places because it provides a good vantage point for watching for prey and gives cats a feeling of security. In contrast to the cat's natural instincts, most furniture for cats, such as a bed, is designed for placement on the floor. In addition, most furniture is inflexible and can not be reconfigured to accommodate different needs and tastes by the pet and its owner.

Therefore, a pet enclosure is needed that can be wall mounted and is modular for reconfiguration according to a pet owner's needs and tastes.

### DESCRIPTION OF THE DRAWINGS

In the accompanying drawings which form part of the specification:

FIG. 1 is a perspective view of a modular pet assembly mounted on a wall;

FIG. 2 is an exploded perspective view of the modular pet assembly;

FIG. 3A is a top view of a dowel fastener;

FIG. 4A is a top view of a cam-lock;

FIG. 4B is a side view of the cam-lock;

FIG. 5 is a top view of a dowel fastener engaged with a lateral member;

FIG. 6 is a top view of a dowel fastener and cam-lock engaged with a lateral member;

FIG. 7 is a perspective view of an alternate embodiment of the modular pet assembly mounted on the wall; and

FIG. 8 is another perspective view of the alternate embodiment of the modular pet assembly mounted on the wall and defining open slots.

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the claimed invention, describes several embodiments, adaptations, variations, alternatives, and uses of the claimed invention, including what is presently believed to be the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

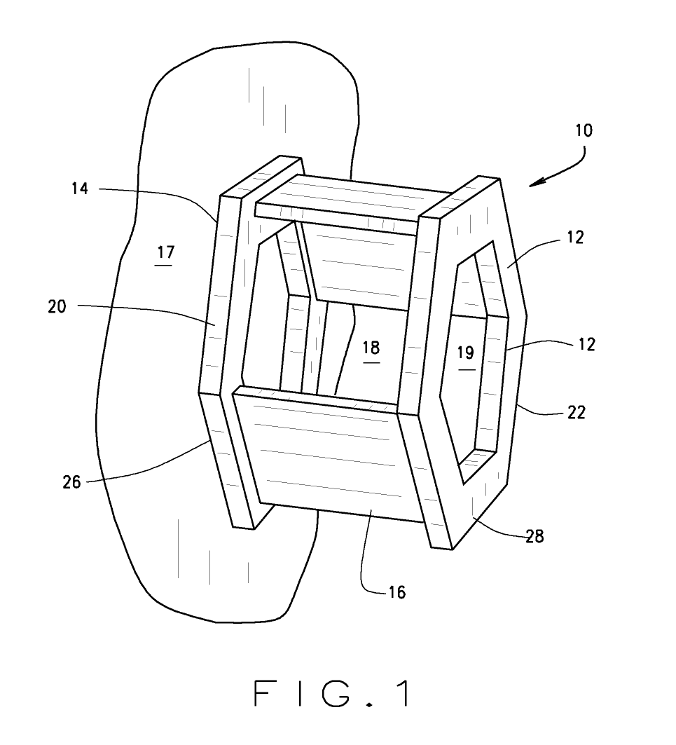

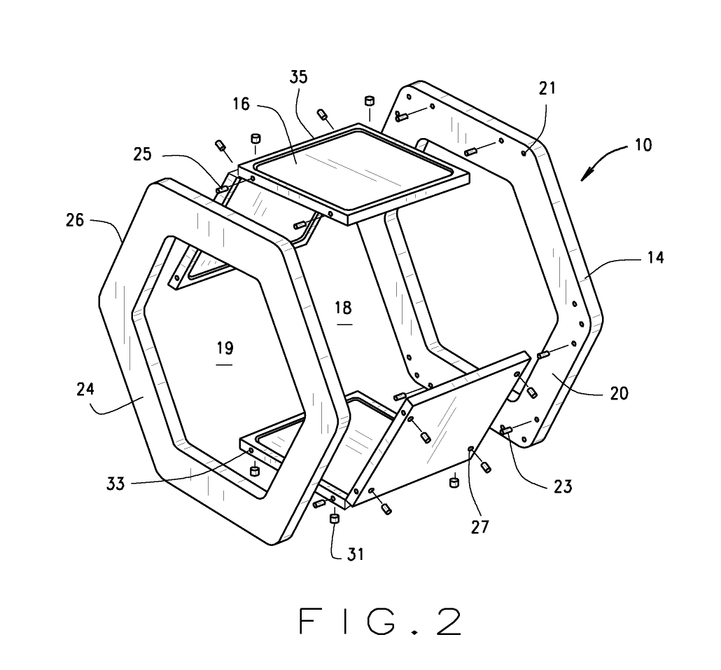

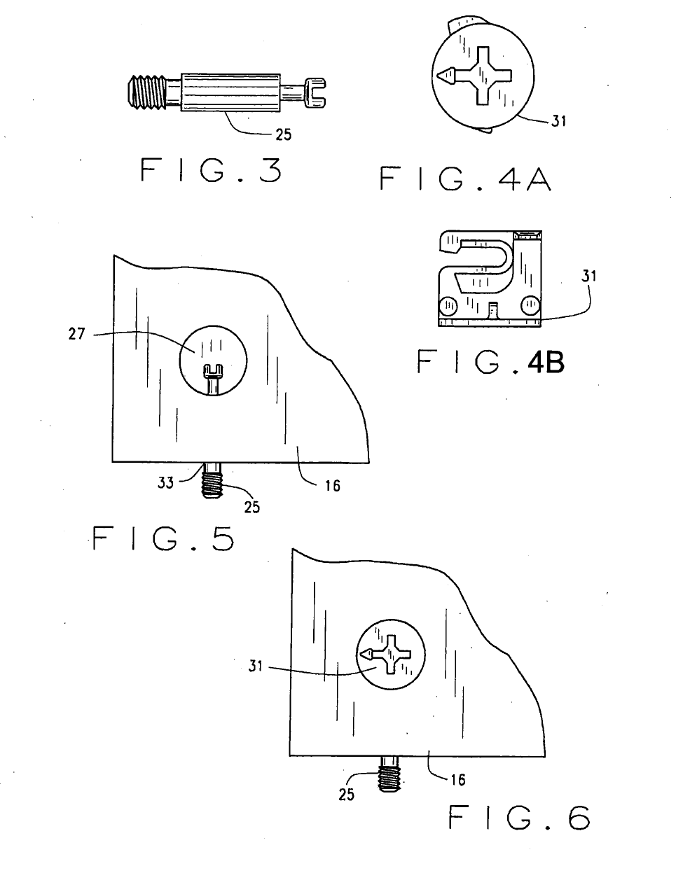

As shown in FIGS. 1-6, an embodiment constructed in accordance with the present disclosure, generally referred to as a modular pet assembly 10, is configured as a generally hexagonal prism that includes a pair of end members 12 and 14 connected by a plurality of lateral members 16. The modular pet assembly 10 can be mounted on a wall 17 so that a pet can perch on top of the assembly 10 or within a chamber 18 defined by the end members 12 and 14 and lateral members 16.

Although the embodiment of FIGS. 1-3 is preferably for use by a domestic cat, the assembly 10 can be used by any domesticated or tamed animal, including, but not limited to, dogs, rabbits, reptiles, and ferrets.

Each of the end members 12 and 14 is generally a planar hexagonal panel that defines a through hole 19, an inner face 20, an outer face 22, an inner edge 24, and an outer edge 26. However, the end members 12 and 14 can be any suitable shape and size, such as, square, octagonal, pentagonal, circular or oval. The through hole 19 is preferably hexagonal shaped to generally correspond to the shape of the end members 12 and 14. However, the through hole 19 can be any shape and size that that allows a pet to enter and exit the assembly 10, such as square, octagonal, pentagonal, circular or oval. The inner face 20 defines a plurality of dowel recesses 21 shaped and sized to receive fasteners 23, such as dowel and cam-lock fasteners. Each dowel recess 21 should be sized and shaped to receive a dowel 25.

Each lateral member 16 is a generally rectangular planar panel defining cam recesses 27 in the inner face 29 shaped and sized to receive a cam-lock 31. Corresponding through holes 33 extend from the cam recess 27 to an edge 35 for alignment with a corresponding dowel recess 21 of the end member 12 or 14. To enhance the comfort of the assembly 10, the lateral member 16 can be at least partially enclosed by a suitable covering, including, but not limited to, carpet, felt, fabric, upholstery, canvas, sisal, fleece, cork, and the like.

The assembly 10 is preferably made from wood, but can also be made from any other suitable material or combination of materials, including, but not limited to, plastic, metal, glass, ceramic, particle board, or other suitable material.

The assembly 10 components can be assembled using fasteners 23 to secure the lateral members 16 between the end members 12 and 14. For instance, dowels 25 are secured in the dowel recesses 21 and extend through the through holes 33 to secure with the cam-locks 31 within the cam recesses 27. Any number of lateral members 16 can engage the end members 12 and 14 at any of the positions defined by the recesses 21 and 27. In this way, the assembly 10 can be assembled into numerous different configurations. For example, with the hexagonal configuration shown, four lateral members 16 are connected between the end members 12 and 14. Alternatively, three lateral members 16 can be mounted in the lowermost available positions such as shown in FIG. 1, and a single lateral member 16 located at the uppermost position as shown in FIG. 1.

The end members 12 and 14 can have other shapes, such as square, oval, circular, or octagonal.

The assembly 10 is mounted to the wall 17 at an appropriate height for the pet using a suitable means, such as fasteners, including but not limited to, nails, screws, French clip, anchors, or adhesive. The modular design of the assembly 10 permits shipping and transport in an unassembled position, thereby reducing cost. When unassembled, the assembly can be configured into a reduced volume arrangement to reduce the size for storage, transport, and shipping. The reduced volume arrangement can comprise any suitable arrangement, including, but not limited to, rectangular, hexagonal, and the like.

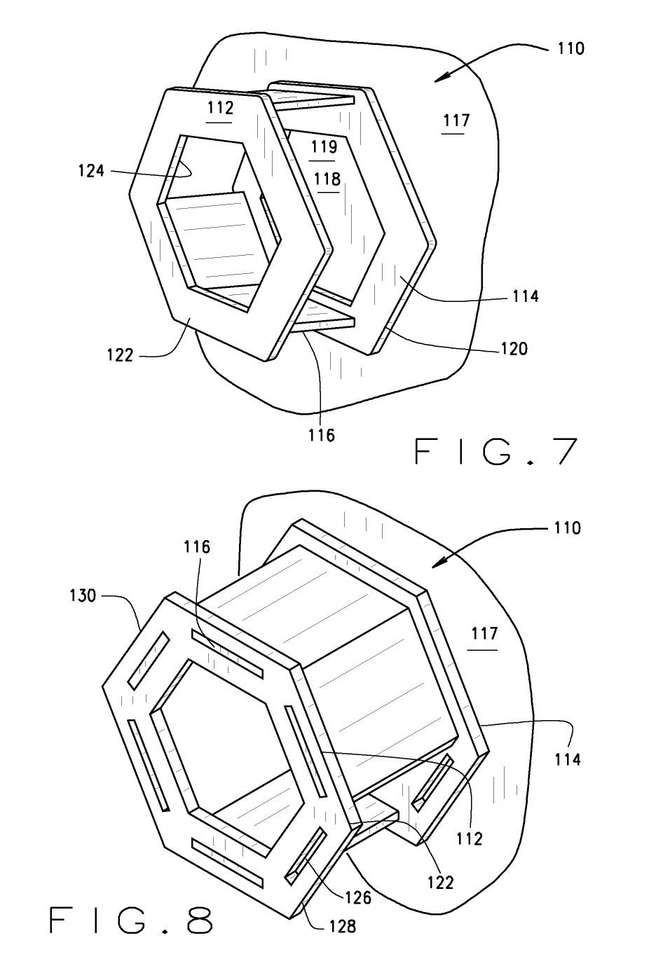

In an alternate embodiment shown in FIGS. 7-8, each of the end members 112 and 114 is generally a planar hexagonal panel that defines a through hole 119, an inner face 120, an outer face 122, an inner edge 124, and an outer edge 126. However, the end members 112 and 114 can be any suitable shape and size, such as, square, octagonal, pentagonal, circular or oval. The through hole 118 is preferably hexagonal shaped to generally correspond to the shape of the end members 112 and 114. However, the through hole 118 can be any shape and size that that allows a pet to enter and exit the assembly 110, such as square, octagonal, pentagonal, circular or oval. The inner face 120 defines a plurality of grooves 126 shaped and sized to receive corresponding lateral members 116. In FIGS. 7-8, each groove 126 is generally rectangular with a length about equal to a corresponding segment 128 of the end members 112 and 114 and positioned generally parallel with the corresponding segment 128. The groove 126 can extend partially or entirely through the thickness of the end members 112 and 114.

Each lateral member 116 is a generally rectangular planar panel with a tongue 130 projecting from each of the ends of member 116. The tongues 130 are sized and shaped to seat within a corresponding groove 126. The tongues 130 and grooves 126 are preferably all of a generally consistent shape and size for interchangeable mating between the any tongue 130 and any groove 126 so that any particular lateral member 116 can be mounted with its tongues 130 inserted with any of the available grooves. To enhance the comfort of the assembly 110, the lateral member 116 can be at least partially enclosed by a suitable covering, including, but not limited to, carpet, felt, fabric, upholstery, canvas, sisal, fleece, cork, and the like.

The assembly 110 is preferably made from wood, but can also be made from any other suitable material or combination of materials, including, but not limited to, plastic, metal, glass, ceramic, particle board, or other suitable material.

The assembly 110 components can be fit together by hand. To assemble, each lateral member 116 can be moved by hand to have its tongues 130 at one end fit within the grooves 126 of one of the end members, such as member 112. After that, the tongues 130 at the opposite ends of lateral members 116 can be inserted into the grooves 126 of the other end member 114. The tongues 130 are secured within the grooves 126 using any suitable method, including, but not limited to, fasteners, friction fit, or adhesive. Any number of lateral members 116 can engage the end members 112 and 114 at any of the positions defined by the grooves 126. In this way, the assembly 110 can be assembled into numerous different configurations. For example, with the hexagonal configuration shown, six lateral members 116 can have their corresponding tongues 130 inserted in the end member 112 and 114. Alternatively, three lateral members 116 can be mounted in the lowermost available positions such as shown in FIG. 8, and a single lateral member 116 located at the uppermost position as shown in FIG. 8.

The grooves 126 are shown as extending completely through the sides of the end members 112 and 114. However the grooves can extend only partially into the inside wall of the end members 112 and 114, so that the outer side of the grooves 126 are closed. This presents a different finish appearance to the exterior of the end members 112 and 114.

The end members 112 and 114 can have other shapes, such as square, oval, circular, or octagonal. In the case of square shaped end members there could be grooves therein to receive the tongues of lateral members so that each side of the end member 112 and 114 could have a corresponding lateral member extending generally parallel with each of its four sides. If the end members are octagonal, eight sets of grooves could be available for eight lateral members with tongues.

The assembly is mounted to the wall 117 at an appropriate height for the pet using a suitable means, such as fasteners, including but not limited to, nails, screws, French clip, anchors, or adhesive. The modular design of the assembly 110 permits shipping and transport in an unassembled position, thereby reducing cost.

Changes can be made in the above constructions without departing from the scope of the invention, it is intended that all matter contained in the above description or shown in the accompanying drawings shall be interpreted as illustrative and not in a limiting sense.

What is claimed is:

1. A modular pet assembly, comprising:
a pair of end members with at least one end member defining an opening sized and shaped for the entrance and exit of a pet, and at least the other end member configured for wall mounting at a selected elevation; and
a lateral member configured for engagement between the end members and configured to support a pet.

2. The modular pet assembly of claim 1, wherein the modular pet assembly is generally of a hexagonal prism shape.

3. The modular pet assembly of claim 1, further comprising a plurality of lateral members for engagement between the end members to define a chamber shaped and sized for accommodation of a pet.

4. The modular pet assembly of claim 1, further comprising a covering attached to at least a portion of a lateral member.

5. The modular pet assembly of claim 1, further comprising dowel and cam fasteners operatively connecting the end members to the lateral member.

6. The modular pet assembly of claim 1, wherein the end members define grooves sized and shaped for interchangeably receiving the ends of the lateral member.

7. The modular pet assembly of claim 1, wherein the lateral member includes a tongue at least at one end that is shaped and sized for interchangeable mating with a groove of an end member.

8. The modular pet assembly of claim 1, wherein the end members and lateral member are shaped and sized for arrangement into an unassembled position for shipping and storage.

9. A modular pet system, comprising:
a first assembled configuration for accommodating a pet; and
a second unassembled configuration for storage and shipping, the modular pet system having a pair of end members at least one member defining an opening sized and shaped for the entrance and exit of a pet, and at least one end member configured for wall mounting at a selected elevation, and a lateral member for interchangeable engagement between the end members at a plurality of locations for arrangement of the modular pet assembly in a plurality of configurations.

10. The modular pet system of claim 9, wherein in the assembled configuration the modular pet assembly is generally of a hexagonal prism shape.

11. The modular pet system of claim 9, wherein in the first assembled configuration the system comprises a plurality of lateral members interchangeably engaged between the end members to define a chamber shaped and sized for accommodation of a pet.

12. The modular pet system of claim 9, further comprising a covering attached to at least a portion a lateral member.

13. The modular pet assembly of claim 9, further comprising dowel and cam fasteners operatively connecting the end members and lateral members.

14. The modular pet system of claim 9, wherein the end members define grooves sized and shaped for interchangeably receiving the lateral member.

15. The modular pet system of claim 9, wherein the lateral member includes a tongue at least at one end of the member, the tongue being shaped and sized for interchangeable mating with the grooves of the end members.

16. A method of shipping a modular pet assembly, comprising the steps of:
providing modular pet assembly components, comprising;
i) a pair of end members, at least one end member defining an opening sized and shaped for the entrance and exit of a pet, and at least one end member configured for wall mounting at a selected elevation; and
ii) a lateral member configured for engagement between the end members and shaped to support the pet;
assembling the modular pet assembly into a reduced volume configuration; and
packaging the modular pet assembly components into a shipping container and substantially maximizing utilization of available shipping space within the shipping container.
